(19) United States
(12) Patent Application Publication
(10) Pub. No.: US 2010/0296169 A1
(43) Pub. Date: Nov. 25, 2010

(54) ANTI-GLARE FILM, METHOD OF MANUFACTURING SAME, AND DISPLAY DEVICE

(75) Inventor: Mikihisa Mizuno, Miyagi (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/777,648

(22) Filed: May 11, 2010

(30) Foreign Application Priority Data
May 19, 2009 (JP) P2009-121434

(51) Int. Cl. G02B 5/02; G02B 1/10

(52) U.S. Cl. 359/599; 427/162

(57) ABSTRACT

An anti-glare film includes a base having an irregular surface and a hard coat layer disposed on the irregular surface of the base. The surface of the hard coat layer has an irregular shape following the irregular surface of the base. The hard coat layer is obtained by applying an ultraviolet curable resin composition to the irregular surface of the base, followed by drying and curing. The ultraviolet curable resin composition contains a monomer and/or oligomer having two or more (meth)acryloyl groups, a photopolymerization initiator, an inorganic oxide filler, a viscosity modifier, and a conductive polymer.

### CROSS REFERENCES TO RELATED APPLICATIONS

The present application claims priority to Japanese Priority Patent Application JP 2009-121434 filed in the Japan Patent Office on May 19, 2009, the entire content of which is hereby incorporated by reference.

### BACKGROUND

The present application relates to an anti-glare film, a method of manufacturing the same, and a display device. More particularly, the present application relates to an anti-glare film.

In recent years, various display devices, such as liquid crystal displays (LCDs) and plasma display panels (PDPs), have been widely used. In the display devices, when glare caused by external light, such as sunlight or indoor lighting, occurs on the screen, visibility is markedly reduced, in particular, in bright places. Therefore, an anti-glare film which diffuse-reflects external light at the screen surface is frequently used.

In existing anti-glare films, in order to diffuse-reflect external light at the screen surface, a method has been used in which a fine irregular structure is formed on the surface. Specifically, at present, a method of forming a diffusion layer on a transparent plastic base by applying a hard coat paint in which transparent fine particles are dispersed in consideration of scratches is predominantly used in liquid crystal display devices.

However, recently, in various display devices represented by flat-screen televisions, image quality has been improved, higher definition has been achieved rapidly, and pixel size has been reduced. Therefore, there may be cases where the light being transmitted through the anti-glare film is strained under the influence of refraction and diffusion due to fine particles in the anti-glare layer and the irregular surface structure, resulting in blurred images, occurrence of glare due to variation in brightness, and discolored surface images, thus significantly degrading the definition. Consequently, in the existing anti-glare films having an irregular surface structure formed using fine particles, it has become difficult to sufficiently follow the improvement in image quality and the increase in definition.

Under these circumstances, a technique has been proposed in which an irregular surface structure is formed without using fine particles. In this technique, an irregular shape is formed on the surface of a base, and an ultraviolet curable resin composition is applied to the irregular surface, followed by curing to form an irregular shape on the surface of the hard coat layer (for example, refer to Japanese Unexamined Patent Application Publication No. 2005-156615). However, in this technique, the ultraviolet curable resin composition planarizes the surface and fills irregularities of the surface of the base, and thus anti-glare properties are reduced.

Furthermore, the plastic base and the hard coat layer (cured acrylic film) are easily charged with electricity and attract dirt and dust easily. Therefore, in recent years, it has been strongly desired to impart antistatic properties to anti-glare films.

### SUMMARY

It is desirable to provide an anti-glare film having excellent anti-glare properties and antistatic properties, a method of manufacturing the same, and a display device including the anti-glare film.

An anti-glare film according to an embodiment includes a base having an irregular surface and a hard coat layer disposed on the irregular surface of the base. The surface of the hard coat layer has an irregular shape following the irregular surface of the base. The hard coat layer is obtained by applying an ultraviolet curable resin composition to the irregular surface of the base, followed by drying and curing. The ultraviolet curable resin composition contains a monomer and/or oligomer having two or more (meth)acryloyl groups, a photopolymerization initiator, an inorganic oxide filler, a viscosity modifier, and a conductive polymer.

A method of manufacturing an anti-glare film according to another embodiment includes the steps of applying an ultraviolet curable resin composition to an irregular surface of a base, drying the applied ultraviolet curable resin composition, and curing the dried ultraviolet curable resin composition to form a hard coat layer. The ultraviolet curable resin composition contains a monomer and/or oligomer having two or more (meth)acryloyl groups, a photopolymerization initiator, an inorganic oxide filler, a viscosity modifier, and a conductive polymer. In the drying step, the surface of the inorganic oxide filler forms bonds with the viscosity modifier, thereby increasing the viscosity of the ultraviolet curable resin composition, and the ultraviolet curable resin composition with the increased viscosity follows the irregular surface of the base.

According to an embodiment, since the ultraviolet curable resin composition contains a conductive polymer, the surface resistance of the anti-glare film is decreased so that antistatic properties can be imparted to the surface of the anti-glare film.

Furthermore, since the ultraviolet curable resin composition contains an inorganic oxide filler and a viscosity modifier, in the drying step, the surface of the inorganic oxide filler forms bonds with the viscosity modifier, thereby increasing the viscosity of the ultraviolet curable resin composition, and the ultraviolet curable resin composition with the increased viscosity follows the irregular surface of the base. Consequently, an irregular shape following the irregular surface of the base is formed on the surface of the hard coat layer, and anti-glare properties can be obtained.

As described above, according to the embodiments of the present invention, it is possible to obtain an anti-glare film having excellent anti-glare properties and antistatic properties.

Additional features and advantages are described herein, and will be apparent from the following Detailed Description and the figures.

### BRIEF DESCRIPTION OF THE FIGURES

FIG. 1 is a cross-sectional view showing an example of a structure of an anti-glare film according to a first embodiment;

FIGS. 2A to 2C are cross-sectional views illustrating examples of steps of a method of manufacturing an anti-glare film according to the first embodiment;

FIGS. 3A to 3C are cross-sectional views illustrating examples of steps of the method of manufacturing an anti-glare film according to the first embodiment;

FIGS. 4A to 4C are cross-sectional views illustrating steps of a method of forming a master according to a second embodiment;

FIGS. 5A to 5D are cross-sectional views illustrating steps of the method of forming a master according to the second embodiment; and

FIG. 6 is a cross-sectional view showing an example of a structure of a liquid crystal display device according to a third embodiment.

### DETAILED DESCRIPTION

The present application will be described with reference to the drawings according to an embodiment in the following order:

1. First Embodiment (example of anti-glare film)

2. Second Embodiment (example in which master is formed using photolithography)

3. Third Embodiment (example in which anti-glare film is applied to surface of display device)

### 1. First Embodiment

### Structure of Anti-Glare Film

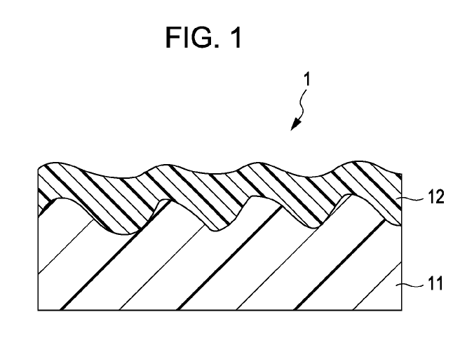

FIG. 1 is a cross-sectional view showing an example of a structure of an anti-glare film according to a first embodiment. As shown in FIG. 1, an anti-glare film 1 according to the first embodiment includes a base 11 having an irregular surface and a hard coat layer 12 disposed on the irregular surface of the base 11. The surface of the hard coat layer 12 has an irregular shape following the irregular surface of the base 11. The irregular shape of the surface of the hard coat layer is preferably three-dimensionally random. The reason for this is that occurrence of moire can be suppressed. The term “three-dimensionally random” means that irregularities are randomly formed in the in-plane direction of the anti-glare film 1 and irregularities are also randomly formed in the thickness direction (in the height direction of irregularities) of the anti-glare film 1.

Preferably, the projection height most frequently observed on the surface of the anti-glare film is in a range of 0.1 to 5 μm. When the projection height most frequently observed is less than 0.1 μm, anti-glare properties tend to become insufficient. On the other hand, when the projection height most frequently observed exceeds 5 μm, roughness and graininess tend to occur in the anti-glare film 1. In addition, anti-glare properties tend to be enhanced excessively, resulting in formation of a discolored anti-glare film 1. The height of projections larger than the projection height most frequently observed on the surface of the anti-glare film is preferably within +1 μm from the center value of the projection height most frequently observed. When out of this range, roughness and graininess tend to occur in the anti-glare film 1. In addition, anti-glare properties tend to be enhanced excessively, resulting in formation of a discolored anti-glare film 1. The length of irregularities in the transverse direction (RSm) on the surface of the anti-glare film is preferably in a range of 55 to 500 μm. When out of this range, anti-glare properties tend to be reduced.

The surface resistivity of the anti-glare film 1 is preferably 10⁸ to 10¹² Ω/square. When the surface resistivity is less than 10⁸ Ω/square, the amount of the conductive polymer to be added increases and the film hardness tends to decrease. On the other hand, when the surface resistivity exceeds 10¹² Ω/square, antistatic properties tend to be reduced, resulting in insufficient dust-proof properties. The Martens hardness of the hard coat layer 12 is preferably 260 to 600 N/mm². When the Martens hardness is less than 260 N/mm², pencil hardness is less than 2H, and the function as a hard coat tends to be reduced. On the other hand, when the Martens hardness exceeds 600 N/mm², the flexibility of the cured film tends to be decreased. The pencil hardness of the hard coat layer 12 is preferably 2H or higher, and more preferably 3H or higher.

(Base)

Preferably, the surface of the base 11 has a random irregular shape. The projection height most frequently observed on the surface of the base is preferably 0.5 to 10 μm. When the projection height most frequently observed is less than 1.5 μm, it tends to be difficult to obtain anti-glare properties while securing the hardness of the hard coat layer 12. When the projection height most frequently observed exceeds 10 μm, roughness and graininess tend to occur in the anti-glare film 1. In addition, anti-glare properties tend to be enhanced excessively, resulting in formation of a discolored anti-glare film 1. The height of projections larger than the projection height most frequently observed on the surface of the base is preferably within +3 μm, more preferably +2 μm, from the center value of the projection height most frequently observed. When within +3 μm, occurrence of roughness and graininess in the anti-glare film 1 is suppressed, and excellent anti-glare properties can be obtained. The length of irregularities in the transverse direction (RSm) on the surface of the base is preferably in a range of 55 to 500 μm. When out of this range, anti-glare properties tend to be reduced.

The base 11, for example, is in the shape of a film. The term “film” is defined to include a film. As the material for the base 11, for example, an existing polymer material can be used. Examples of the existing polymer material include triacetyl cellulose (TAC), polyester (TPEE), polyethylene terephthalate (PET), polyimide (PI), polyamide (PA), aramid, polyethylene (PE), polyacrylate, polyethersulfone, polysulfone, polypropylene (PP), diacetyl cellulose, polyvinyl chloride, an acrylic resin (PMMA), polycarbonate (PC), an epoxy resin, a urea resin, a urethane resin, a melamine resin, a cyclo-olefin resin (e.g., ZEONOR (registered trademark)), and a styrene-butadiene copolymer (SBC). In view of productivity, the thickness of the base 11 is preferably 38 to 100 μm, although not limited to this range.

(Hard Coat Layer)

The hard coat layer 12 imparts scratch resistance and anti-glare properties to the surface of the base 11, namely, the surface of the anti-glare film 1, a display device, or the like, and is a polymer resin layer that is harder than the base 11. Preferably, a continuous corrugated pattern, which follows the irregularities of the base 11, is formed on the surface of the hard coat layer. The reason for this is that diffusion of light by such a surface of the hard coat layer can exhibit moderate anti-glare properties. Preferably, the positions of projections and depressions of the hard coat layer 12 correspond to the positions of projections and depressions of the base 11.

The hard coat layer 12 is formed by applying an ultraviolet curable resin composition to the irregularities of the base 11, followed by drying and curing. The ultraviolet curable resin composition contains an acrylate, a photopolymerization initiator, an inorganic oxide filler, a viscosity modifier, and a conductive polymer. Preferably, the ultraviolet curable resin composition further contains an antifouling agent from the standpoint of imparting antifouling properties. Preferably, the ultraviolet curable resin composition further contains a leveling agent from the standpoint of improving wettability to the base 11. Furthermore, as necessary, the ultraviolet curable resin composition may contain an organic or inorganic filler which imparts internal haze to the hard coat. When the ultraviolet curable resin contains the filler, the difference in refractive index between the filler and the matrix is preferably 0.01 or more. The average particle size of the filler is preferably 0.1 to 1 μm. Furthermore, as necessary, the ultraviolet curable resin composition may contain a light stabilizer, a flame retarder, an antioxidant, and the like.

The acrylate, the photopolymerization initiator, the inorganic oxide filler, the viscosity modifier, the conductive polymer, the antifouling agent, and the leveling agent will be described below in that order.

(Acrylate)

As the acrylate, a monomer and/or oligomer having two or more (meth)acryloyl groups is preferably used. As the monomer and/or oligomer, for example, urethane acrylate, epoxy acrylate, polyester acrylate, polyol acrylate, polyether acrylate, melamine acrylate, or the like may be used. For example, urethane acrylate can be obtained by allowing polyester polyol to react with an isocyanate monomer or prepolymer, and allowing the resulting product to react with a hydroxy group-containing acrylate or methacrylate monomer. The term “(meth)acryloyl group” means either acryloyl group or methacryloyl group. The oligomer refers to a molecule having a molecular weight of 500 to 60,000.

(Photopolymerization Initiator)

As the photopolymerization initiator, any photopolymerization initiator appropriately selected from existing materials can be used. Examples of the existing materials include benzophenone derivatives, acetophenone derivatives, and anthraquinone derivatives. These may be used alone or in combination of two or more. The amount of the polymerization initiator to be added is preferably 0.1% to 10% by mass of the solid content. When the amount is less than 0.1% by mass, photocurability is reduced, thus being substantially unsuitable for industrial production. On the other hand, when the amount exceeds 10% by mass and if the irradiation light amount is small, odor tends to remain in the coating film. The term “solid content” refers to all the components constituting the hard coat layer 12 after being cured, for example, all the components except for a solvent and a viscosity modifier. Specifically, for example, the solid content refers to an acrylate, a photopolymerization initiator, an inorganic oxide filler, a conductive polymer, a leveling agent, and an antifouling agent.

(Inorganic Oxide Filler)

As the inorganic oxide filler, for example, silica, alumina, zirconia, antimony pentoxide, zinc oxide, tin oxide, indium tin oxide (ITO), indium oxide, antimony-doped tin oxide (ATO), aluminum zinc oxide (AZO), or the like can be used. Preferably, the surface of the inorganic oxide filler is treated with an organic dispersant having a functional group, such as a (meth)acrylic group, a vinyl group, or an epoxy group, at an end. As the organic dispersant, for example, a silane coupling agent having the functional group at an end is suitable. Examples of the silane coupling agent having an acrylic group at an end include KBM-5103 manufactured by Shin-Etsu Chemical Co., Ltd. Examples of the silane coupling agent having a methacrylic group at an end include KBM-502, KBM-503, KBE-502, and KBE-503 manufactured by Shin-Etsu Chemical Co., Ltd. Examples of the silane coupling agent having a vinyl group at an end include KA-1003, KBM-1003, and KBE-1003 manufactured by Shin-Etsu Chemical Co., Ltd. Examples of the silane coupling agent having an epoxy group at an end include KBM-303, KBM-403, KBE-402, and KBE-403 manufactured by Shin-Etsu Chemical Co., Ltd. Besides the silane coupling agent, an organic carboxylic acid may be used. By using the thus surface-treated inorganic oxide filler, in the coating film curing step described below, the inorganic oxide filler is integrated into its surrounding acrylate, such as a (meth)acrylic monomer and/or oligomer, thus improving coating film hardness and flexibility.

Preferably, the inorganic oxide filler has an OH group or the like on its surface. In this case, in the coating film drying step described below, during the process of evaporation of the solvent, the OH group or the like on the surface of the inorganic oxide filler and the functional group of the viscosity modifier are hydrogen-bonded or coordination-bonded to each other. Consequently, the viscosity of the coating liquid increases, and preferably, the coating liquid gelates. Since the viscosity increases, the coating liquid follows the irregular shape of the base 11, and an irregular shape following the irregular shape of the base 21 is formed on the surface of the coating liquid.

The average particle size of the inorganic oxide filler is, for example, 1 to 100 nm. The amount of the inorganic oxide filler to be added is preferably 10% to 70% by mass of the solid content. Note that the total solid content is considered as 100% by mass. When the amount is less than 10% by mass, the viscosity does not increase during the process of evaporation of the solvent, or the amount of the viscosity modifier to be used for increasing viscosity becomes too large, and as a result, there is a tendency that turbidity occurs in the coating material or the coating film hardness decreases. On the other hand, when the amount exceeds 70% by mass, flexibility of the cured film tends to decrease.

(Viscosity Modifier)

As the viscosity modifier, for example, a compound having in its molecule a hydroxy group (OH group), a carboxyl group (COOH group), a urea group (—NH—CO—NH—), an amide group (—NH—CO—), or an amino group (NH₂ group) can be used. Preferably, a compound having at least two functional groups of at least one type of functional group selected from the functional groups described above is used. Furthermore, as the viscosity modifier, from the standpoint of suppressing agglomeration of the inorganic oxide filler, use of a compound having in its molecule a carboxyl group is preferable. An anti-sagging agent and an anti-settling agent can also be used. Examples of the viscosity modifier that can be preferably used include BYK-405, BYK-410, BYK-411, BYK-430, and BYK-431 manufactured by BYK Japan KK; and TALEN 1450, TALEN 2200A, TALEN 2450, FLOWLEN G-700, and FLOWLEN G-900 manufactured by Kyoeisha Chemical Co., Ltd. The amount of the viscosity modifier to be added is preferably 0.001 to 5 parts by mass relative to 100 parts by mass of the total coating material. Preferably, the optimum amount to be added is appropriately selected according to the material type and the amount to be added of the inorganic oxide filler, the material type of the viscosity modifier, and the desired thickness of the hard coat layer.

(Conductive Polymer)

Examples of the conductive polymer include substituted or unsubstituted polyaniline, polypyrrole, polythiophene, and a (co)polymer including one or two of these. In particular, polypyrrole, polythiophene, poly(N-methylpyrrole), poly(3-methylthiophene), poly(3-methoxythiophene), poly(3,4-ethylenedioxythiophene), and a (co)polymer including one or two of these are preferable. Furthermore, in view of low coloration, namely, high transparency, polythiophene is preferable.

As the conductive polymer, a conductive polymer that has high compatibility with the ultraviolet curable resin composition is preferably selected. When compatibility is low, the amount of the conductive polymer to be used for obtaining the desired antistatic properties increases, resulting in degradation in mechanical properties and coloration (degradation in transparency).

From the standpoint of improving conductivity, the conductive polymer preferably contains a dopant. As the dopant, for example, a halogenated compound, a Lewis acid, a protonic acid, or the like may be used. Specific examples thereof include organic acids, such as organic carboxylic acids and organic sulfonic acids, organic cyano compounds, fullerenes, hydrogenated fullerenes, carboxylated fullerenes, and sulfonated fullerenes. A polystyrene sulfonic acid-doped polyethylenedioxythiophene solution has relatively high thermal stability and a low degree of polymerization, and thus is preferable in view that transparency after formation of the coating film is advantageous. In terms of practical characteristics, reliability, and the like, the conductive polymer is believed to be superior to an antistatic agent, such as a quaternary ammonium salt or an ionic liquid.

(Antifouling Agent)

As described above, preferably, the ultraviolet curable resin composition further contains an antifouling agent. As the antifouling agent, a silicone oligomer having one or more (meth)acrylic groups, vinyl groups, or epoxy groups and/or a fluorine-containing oligomer is preferably used. When it is necessary to impart alkali resistance to the anti-glare film 1, use of the fluorine-containing oligomer is preferable. The amount of the silicone oligomer and/or the fluorine-containing oligomer to be added is preferably 0.01% to 5% by mass of the solid content. When the amount is less than 0.01% by mass, the antifouling function tends to be insufficient. On the other hand, when the amount exceeds 5% by mass, the coating film hardness tends decrease. Examples of the antifouling agent that can be preferably used include RS-602 and RS-751-K manufactured by DIC Corporation, CN4000 manufactured by Sartomer Corp., OPTOOL DAC-HP manufactured by Daikin Industries, Ltd., X-22-164E manufactured by Shin-Etsu Chemical Co., Ltd., FM-7725 manufactured by Chisso Corporation, EBECRYL350 manufactured by Daicel-Cytec Company Ltd., and TEGORad2700 manufactured by Degussa AG.

(Leveling Agent)

As described above, preferably, the ultraviolet curable resin composition further contains a leveling agent from the standpoint of improving wettability on the base 11. The amount of the leveling agent to be added is preferably 0.01% to 5% by mass of the solid content. When the amount is less than 0.01% by mass, improvement in wettability tends to become insufficient. When the amount exceeds 5% by mass, the coating film hardness tends to decrease.

[Method of Manufacturing Anti-Glare Film]

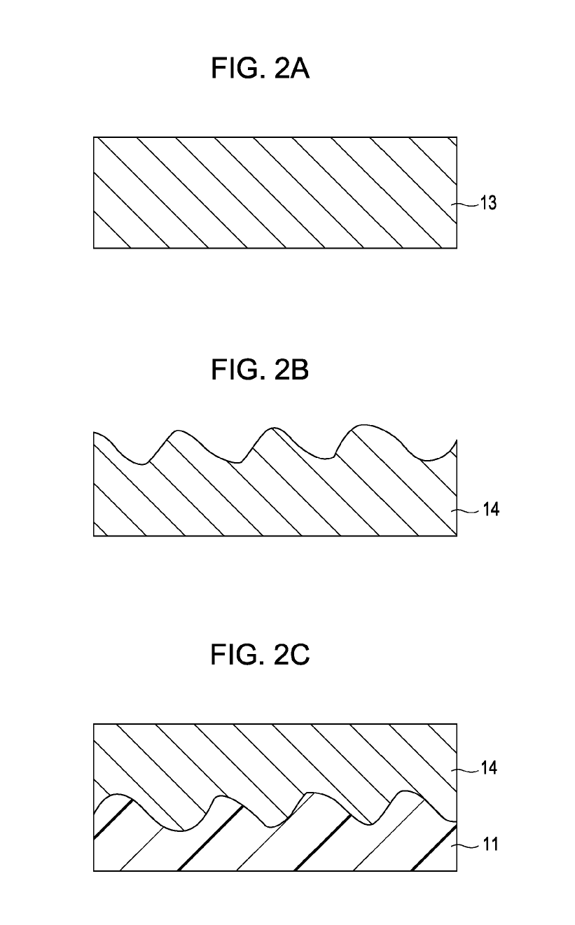

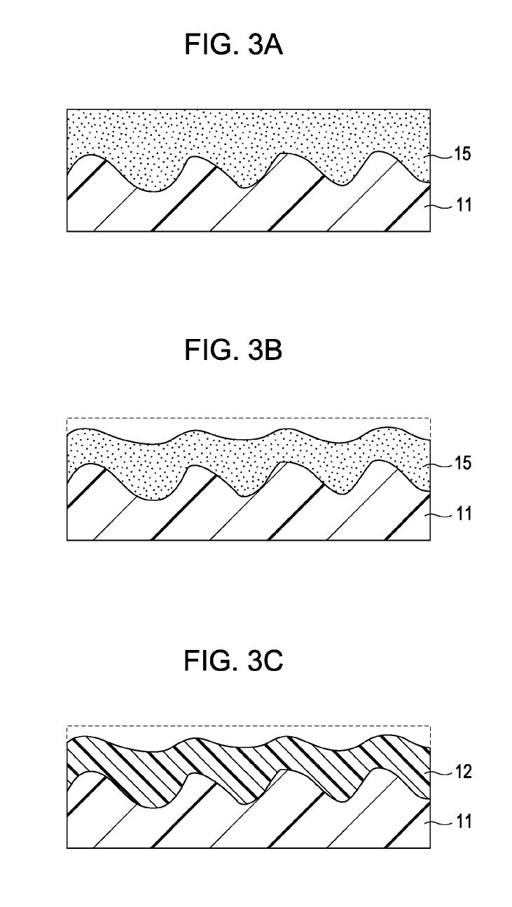

An example of a method of manufacturing an anti-glare film according to the first embodiment of the present invention will now be described with reference to FIGS. 2A to 2C and 3A to 3C.

(Master Formation Step)

First, as shown in FIG. 2A, a base 13, which is to be worked, is prepared. The base 13 is, for example, plate-shaped, sheet-shaped, film-shaped, block-shaped, columnar, cylindrical, or the like. As the material for the base 13, for example, a metal or the like may be used. Next, an irregular shape is formed on the surface of the base by blasting. Thereby, as shown in FIG. 2B, a master 14 having an irregular shape which is reverse to the irregular shape of the base 11 is obtained.

Blasting is a technique in which a workpiece is bombarded with fine particles to form random irregularities on the surface of the master. The irregular shape formed by blasting has three-dimensional randomness. Consequently, the anti-glare film 1 formed using the master 14 can suppress occurrence of moire.

(Transfer Step)

Next, as shown in FIG. 2C, by pressing the master 14 against the smooth surface of the base 11 and heating the base 11, the irregular shape of the master 14 is transferred to the base 11.

(Coating Material Preparation Step)

Next, for example, an acrylate, a photopolymerization initiator, an inorganic oxide filler, a viscosity modifier, a conductive polymer, and a solvent are mixed together to prepare an ultraviolet curable resin composition.

As the solvent, a solvent which dissolves the resin material to be used, which has good wettability to the base 11, and which does not whiten the base 11 is preferable. Examples of the solvent include ketones, such as acetone, diethyl ketone, dipropyl ketone, methyl ethyl ketone, methyl butyl ketone, methyl isobutyl ketone, cyclohexane, methyl formate, ethyl formate, propyl formate, isopropyl formate, butyl formate, methyl acetate, ethyl acetate, propyl acetate, isopropyl acetate, butyl acetate, isobutyl acetate, sec-butyl acetate, amyl acetate, isoamyl acetate, sec-amyl acetate, methyl propionate, ethyl propionate, methyl butyrate, ethyl butyrate, and methyl lactate; carboxylic acid esters; alcohols, such as methanol, ethanol, isopropanol, n-butanol, sec-butanol, and tert-butanol; and ethers, such as tetrahydrofuran, 1,4-dioxane, and 1,3-dioxolane. These solvents may be used alone or in combination of two or more. Furthermore, a solvent other than those mentioned above may be added in a range that does not impair the performance of the resin material.

(Coating Step)

Next, as shown in FIG. 3A, the prepared ultraviolet curable resin composition 15 is applied by coating onto the irregularities of the base 11. The coating method is not particularly limited, and any of the existing coating methods may be used. Examples of the coating methods include micro-gravure coating, wire-bar coating, direct gravure coating, die coating, dipping, spray coating, reverse roll coating, curtain coating, comma coating, knife coating, and spin coating.

(Drying Step)

Next, as shown in FIG. 3B, by drying the ultraviolet curable resin composition applied by coating onto the irregular surface of the base 11, the solvent is volatilized. The drying conditions are not particularly limited. Natural drying or artificial drying in which drying temperature and drying time are adjusted may be used. In the case where wind is applied to the surface of the coating material during drying, it is preferable to prevent wind ripples from forming on the surface of the coating film. Furthermore, drying temperature and drying time can be appropriately set according to the boiling point of the solvent contained in the coating material. In this case, the drying temperature and drying time are preferably selected, in consideration of heat resistance of the base 11, within the ranges which do not cause deformation of the base 11 due to heat shrinkage.

In the solvent evaporation process, the solid content concentration in the system increases, the inorganic oxide filler and the viscosity modifier form networks through bonding, such as hydrogen bonding or coordination bonding, in the system, thus increasing the viscosity. Because of the increase in viscosity, the irregular shape of the base 11 is left on the surface of the dried ultraviolet curable resin composition. That is, moderate smoothness is formed on the surface of the dried ultraviolet curable resin composition, and thus anti-glare properties are exhibited. When the viscosity of the ultraviolet curable resin composition increases in the solvent evaporation process as described above, the dried ultraviolet curable resin composition follows the irregular shape of the base 11 and, as a result, anti-glare properties are exhibited. In contrast, when the viscosity of the ultraviolet curable resin composition does not increase, the dried ultraviolet curable resin composition flattens the irregular shape of the base 11, and it is not possible to obtain anti-glare properties.

(Curing Step)

Next, the ultraviolet curable resin composition applied by coating onto the irregular surface of the base 11 is cured, for example, by ultraviolet irradiation. Thereby, as shown in FIG. 3C, a hard coat layer 12 is formed on the base 11. The cumulative dose of ultraviolet light is preferably appropriately selected in consideration of curing characteristics of the ultraviolet curable resin composition and suppression of yellowing of the ultraviolet curable resin composition and the base 11. Furthermore, the irradiation may be performed in an inert gas atmosphere, such as nitrogen or argon.

The intended anti-glare film 1 can be obtained by the steps described above.

According to the first embodiment, the ultraviolet curable resin composition contains, for example, a difunctional or higher (meth)acrylic monomer and/or oligomer, a photopolymerization initiator, an inorganic oxide filler, a viscosity modifier, a conductive polymer, and a solvent. As described above, all the components other than the solvent and the viscosity modifier are defined as the solid content. When the ultraviolet curable resin composition is applied by coating onto a base 11 having an irregular shape, followed by drying and ultraviolet curing, a hard coat layer 12 having a shape that follows the irregular shape is formed. The reason for this is that, in the solvent evaporation process, by the action of the inorganic oxide filler and the viscosity modifier contained in the composition, the viscosity of the solid content increases, and shape followability with respect to the irregularities of the surface of the base is imparted to the ultraviolet curable resin composition.

### 2. Second Embodiment

The second embodiment differs from the first embodiment in that, in the master formation step, the irregular shape of the surface of the base is formed using photolithography instead of blasting. Except for this, the procedure is the same as that in the first embodiment. Therefore, the method of forming the master using photolithography will be described below.

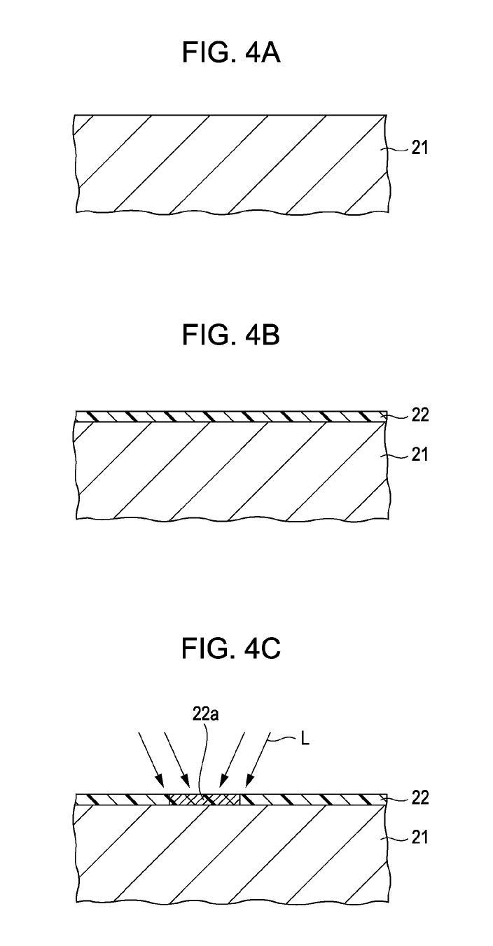

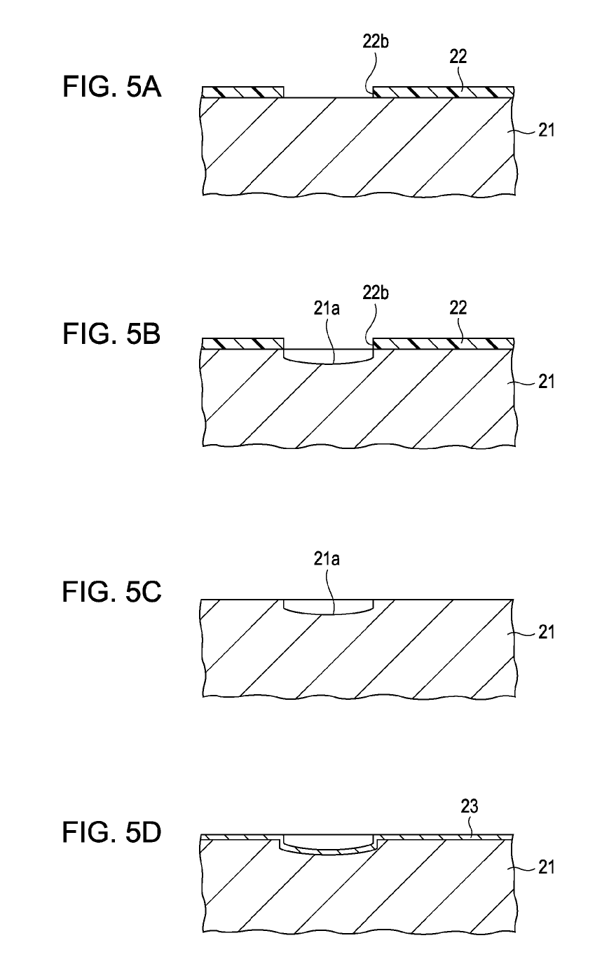

The method of forming a master according to the second embodiment of the present invention will be described below with reference to FIGS. 4A to 4C and 5A to 5D.

(Resist Layer Formation Step)

First, as shown in FIG. 4A, a base 21, which is to be works, is prepared. Next, as shown in FIG. 4B, a resist layer 22 is formed on the surface of the base 21. As the material for the resist layer 22, for example, either an inorganic resist or an organic resist may be used.

(Exposure Step)

Next, for example, as shown in FIG. 4C, by irradiating the resist layer 22 with laser light L, an exposure pattern 22a is formed in the resist layer 22. The exposure pattern 22a is a random pattern. The shape of the exposure pattern 22a may be, for example, circular, elliptical, polygonal, or the like.

(Development Step)

Next, the resist layer 22, for example, provided with the exposure pattern 22a is developed. Thereby, as shown in FIG. 5A, an opening 22b corresponding to the exposure pattern 22a is formed in the resist layer 22. In the example shown in FIG. 5A, a positive type resist is used as the resist and an opening 22b is formed in the exposed portion. However, the resist is not limited to this example. That is, a negative type resist may be used as the resist, and an exposed portion may remain.

(Etching Step)

Next, the surface of the base 21 is etched using, as a mask, the resist layer 22, for example, provided with the opening 22b. Thereby, as shown in FIG. 5B, a recess 21a is formed in the surface of the base 21 at the position corresponding to the opening 22b. As the etching, either dry etching or wet etching may be used. In view of simplicity in equipment, wet etching is preferably used. Furthermore, as the etching, for example, either isotropic etching or anisotropic etching may be used.

(Resist Stripping Step)

Next, as shown in FIG. 5C, the resist layer 22 formed on the surface of the base is stripped, for example, by ashing. Thereby, a master having an irregular shape that is reverse to the irregular shape of the base 11 is obtained.

(Plating Step)

Next, as shown in FIG. 5D, as necessary, the surface of the base 21 is subjected to plating treatment to form a plating layer 23, such as a nickel plating layer.

The intended master can be obtained by the steps described above.

In the second embodiment, the same advantages as those of the first embodiment can be obtained.

### 3. Third Embodiment

### Structure of Liquid Crystal Display Device

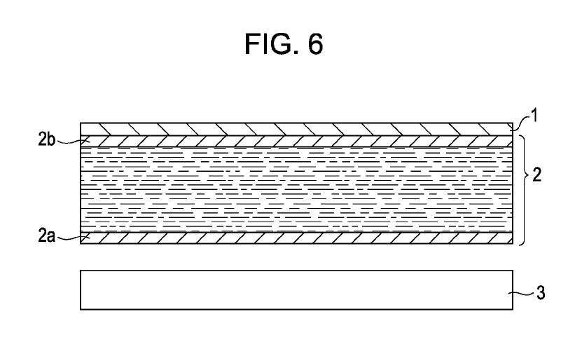

FIG. 6 is a cross-sectional view showing an example of a structure of a liquid crystal display device according to a third embodiment of the present invention. As shown in FIG. 6, the liquid crystal display device includes a backlight 3 which emits light and a liquid crystal panel 2 which modulates light emitted from the backlight 3 in terms of time and space and displays an image. Polarizers 2a and 2b are disposed on both surfaces of the liquid crystal panel 2. An anti-glare film 1 is disposed as an optical film on the polarizer 2b located on the display surface side.

The backlight 3, the liquid crystal panel 2, and the anti-glare film 1 constituting the liquid crystal display device will be described below in that order.

(Backlight)

As the backlight 3, for example, a direct type backlight, an edge type backlight, or a planar light source type backlight may be used. The backlight 3 includes, for example, a light source, a reflector plate, an optical film, and the like. As the light source, for example, a cold cathode fluorescent lamp (CCFL), a hot cathode fluorescent lamp (HCFL), organic electroluminescence (OEL), inorganic electroluminescence (IEL), a light-emitting diode (LED), or the like is used.

(Liquid Crystal Panel)

As the liquid crystal panel 2, a liquid crystal panel having a display mode, such as a twisted nematic (TN) mode, a super twisted nematic (STN) mode, a vertically aligned (VA) mode, an in-plane switching (IPS) mode, an optically compensated birefringence (OCB) more, a ferroelectric liquid crystal (FLC) more, a polymer dispersed liquid crystal (PDLC) mode, or a phase change guest host (PCGH) mode, can be used.

For example, the polarizers 2a and 2b are disposed on both surfaces of the liquid crystal panel 2 such that their transmission axes are orthogonal to each other. The polarizers 2a and 2b transmit only one of the polarized components which are orthogonal to each other, and block by absorption the other component. As each of the polarizers 2a and 2b, for example, a polyvinyl alcohol (PVA) film on which an iodine complex or a dichromatic dye is arranged in a uniaxial direction can be used. Preferably, a protective layer, such as a triacetyl cellulose (TAC) film, is disposed on the surface of each of the polarizers 2a and 2b. When the protective layer is used, preferably, the protective layer is configured to also serve as a base of the anti-glare film 1. The reason for this is that by using such a configuration, the thickness of the polarizers 2a and 2b can be decreased.

(Anti-Glare Film)

The anti-glare film 1 is the same as the first embodiment described above, and the description thereof will be omitted.

According to the third embodiment, since the anti-glare film 1 is disposed on the display surface of the liquid crystal display device, it is possible to impart anti-glare properties and antistatic properties to the display surface of the liquid crystal panel 2. It is also possible to impart scratch resistance to the display surface of the liquid crystal panel 2.

### EXAMPLES

The present application will be specifically described below on the basis of examples. However, it is to be understood that the present invention is not limited to the examples.

In the examples, the thickness (average thickness) of the hard coat layer was measured using a thickness meter (manufactured by TESA, Electric Micrometer) as follows:

First, a contact terminal with a cylindrical shape having a diameter of 6 mm was brought into contact with a hard coat layer under a low load which does not flatten the hard coat layer, and the thickness of the anti-glare film was measured at given five points. Next, the measured thicknesses of the anti-glare film were simply averaged to obtain the average value D_{A} of the total thickness of the anti-glare film. Next, the thickness of the uncoated portion of the same anti-glare film was measured at given five points. Next, the measured thicknesses of the base (TAC film) were simply averaged to obtain the average thickness D_{B} of the base was obtained. Next, the average thickness D_{B} of the base was subtracted from the average value D_{A} of the total thickness of the anti-glare film, and the obtained value was defined as the thickness of the hard coat layer.

### Example 1

First, a master having an irregular shape on the surface was formed by photolithography. Next, irregularities were formed on the surface of a TAC film (manufactured by Fuji Photo Film Co., Ltd.; film thickness: 80 μm) by a shape transfer process using the master. Next, using stylus-type surface roughness measuring instrument (manufactured by Kosaka Laboratory Ltd.; trade name: Surfcorder ET4000), the irregular shape of the surface of the base was evaluated. The results were as follows: Ra (arithmetical mean roughness)=0.903 μm, Rz (ten-point mean roughness)=2.907 μm, and RSm (mean spacing of profile irregularities)=65 μm.

Next, an ultraviolet curable resin composition having the composition described below was applied by coating to the irregular surface of the TAC film using a coil bar. After the coating was performed, the ultraviolet curable resin composition was dried at 80° C. for 1.5 minutes. Next, the ultraviolet curable resin composition was irradiated with ultraviolet light of 350 mJ/cm² in a nitrogen atmosphere. Thereby, an anti-glare film having a hard coat layer with a thickness of 7 μm was obtained. Next, using stylus-type surface roughness measuring instrument, the surface shape of the hard coat layer was evaluated. The results were as follows: Ra=0.081 μm, Rz=0.292 μm, and RSm=86 μm.

(Composition)

| | |
|---|---|
| Urethane acrylate | 14.08 parts by mass |
| | (manufactured by Kyoeisha |
| | Chemical Co., Ltd.; trade name: UA-510H) |
| Polyfunctional acrylic monomer: | 7.04 parts by mass |
| pentaerythritol tetraacrylate | (manufactured by Shin Nakamura Chemical Co., |
| | Ltd.; trade name: A-TMMT) |
| Silica filler | 15.37 parts by mass |
| | (manufactured by JGC Catalysts and Chemicals Ltd.; |
| | OSCAL series, particle size 25 nm; the surface of |
| | particles being treated with a silane coupling agent |
| | containing a terminal acrylic group |
| | (e.g., KBM-5103 manufactured by Shin-Etsu Chemical Co., Ltd.)) |
| Polymerization initiator | 1.92 parts by mass |
| | (manufactured by Ciba Specialty Chemicals; |
| | trade name: Irgacure 184) |
| Leveling agent: | 0.06 parts by mass |
| 3-methoxy-3-methyl-1-butanol | (manufactured by Kyoeisha Chemical Co., Ltd.; |
| solution of 30% by mass active | trade name: KL-600) |
| constituent (fluorine-containing | |
| acrylic polymer) | |
| Conductive polymer solution: | 38.43 parts by mass |
| IPA solution of polystyrene | (manufactured by Shin-Etsu Polymer Co., Ltd.; |
| sulfonic acid-doped | trade name: SAS-PD (IPA solution of 4% by |
| polyethylenedioxythiophene | mass active constituent (conductive polymer)) |
| Viscosity modifier: | 0.04 parts by mass |
| carboxyl group-containing | (manufactured by Kyoeisha Chemical Co., Ltd.; |
| modified polymer | trade name: G-700) |
| Solvent: isopropyl alcohol (IPA) | 23.06 parts by mass |

### Example 2

An anti-glare film having a hard coat layer with a thickness of 7 μm was obtained as in Example 1 except that the ultraviolet curable resin composition having the composition described below was prepared by increasing the amount of the conductive polymer used in the solid content.

(Composition)

| | |
|---|---|
| Urethane acrylate | 12.20 parts by mass |
| Polyfunctional acrylic monomer: | 6.10 parts by mass |
| pentaerythritol tetraacrylate | |
| Silica filler | 13.32 parts by mass |
| Polymerization initiator | 1.67 parts by mass |
| Leveling agent: | 0.06 parts by mass |
| 3-methoxy-3-methyl-1-butanol | |
| solution of 30% by mass active | |
| constituent (fluorine-containing acrylic polymer) | |
| IPA solution of polystyrene sulfonic | 46.63 parts by mass |
| acid-doped polyethylenedioxythiophene | |
| Viscosity modifier: carboxyl | 0.03 parts by mass |
| group-containing modified polymer | |
| Solvent: isopropyl alcohol (IPA) | 19.99 parts by mass |

Since the materials are the same as those in Example 1, description of names of supplier companies and trade names of the materials are omitted.

### Example 3

An anti-glare film having a hard coat layer with a thickness of 7 μm was obtained as in Example 1 except that the ultraviolet curable resin composition having the composition described below was prepared by increasing the amount of the conductive polymer used in the solid content.

(Composition)

| | |
|---|---|
| Urethane acrylate | 11.44 parts by mass |
| Polyfunctional acrylic monomer: | 5.72 parts by mass |
| pentaerythritol tetraacrylate | |
| Silica filler | 12.49 parts by mass |
| Polymerization initiator | 1.56 parts by mass |
| Leveling agent: | 0.05 parts by mass |
| 3-methoxy-3-methyl-1-butanol | |
| solution of 30% by mass active | |
| constituent (fluorine-containing acrylic polymer) | |
| IPA solution of polystyrene sulfonic | 49.97 parts by mass |
| acid-doped polyethylenedioxythiophene | |
| Viscosity modifier: carboxyl | 0.03 parts by mass |
| group-containing modified polymer | |
| Solvent: isopropyl alcohol (IPA) | 18.74 parts by mass |

Since the materials are the same as those in Example 1, description of names of supplier companies and trade names of the materials are omitted.

### Example 4

An anti-glare film having a hard coat layer with a thickness of 7 μm was obtained as in Example 1 except that the ultraviolet curable resin composition having the composition described below was prepared by adding an antifouling agent.

(Composition)

| | |
|---|---|
| Urethane acrylate | 13.82 parts by mass |
| Polyfunctional acrylic monomer: | 6.91 parts by mass |
| pentaerythritol tetraacrylate | |
| Silica filler | 15.37 parts by mass |
| Polymerization initiator | 1.92 parts by mass |
| Leveling agent: | 0.06 parts by mass |
| 3-methoxy-3-methyl-1-butanol | |
| solution of 30% by mass active | |
| constituent (fluorine-containing acrylic polymer) | |
| IPA solution of polystyrene sulfonic | 38.43 parts by mass |
| acid-doped polyethylenedioxythiophene | |
| Antifouling agent: | 0.38 parts by mass |
| fluorine-containing | (trade name: RS-602, |
| acrylate monomer | manufactured |
| | by DIC Corporation) |
| Viscosity modifier: carboxyl | 0.04 parts by mass |
| group-containing modified polymer | |
| Solvent: isopropyl alcohol (IPA) | 23.07 parts by mass |

Since the materials except for the antifouling agent are the same as those in Example 1, description of names of supplier companies and trade names of the materials except for the antifouling agent are omitted.

### Example 5

An anti-glare film having a hard coat layer with a thickness of 7 μm was obtained as in Example 4 except that trade name: RS-751-K manufactured by DIC Corporation was used as the antifouling agent.

### Example 6

An anti-glare film having a hard coat layer with a thickness of 7 μm was obtained as in Example 4 except that trade name: OPTOOL DAC-HP manufactured by Daikin Industries, Ltd. was used as the antifouling agent.

### Example 7

An anti-glare film having a hard coat layer with a thickness of 7 μm was obtained as in Example 4 except that trade name: EBECRYL350 manufactured by Daicel-Cytec Company Ltd. was used as the antifouling agent.

### Example 8

An anti-glare film having a hard coat layer with a thickness of 10 μm was obtained as in Example 1 except that the amount of the viscosity modifier used was increased to 0.05 parts by mass and the amount of the solvent (IPA) used was decreased to 23.05 parts by mass.

Then, the irregular surface of the anti-glare film was evaluated using stylus-type surface roughness measuring instrument (manufactured by Kosaka Laboratory Ltd.; trade name: Surfcorder ET4000). The results showed that the anti-glare film of Example 8 had substantially the same surface shape as that of Example 1, i.e., anti-glare properties.

### Example 9

An anti-glare film having a hard coat layer with a thickness of 4 μm was obtained as in Example 1 except that the amount of the viscosity modifier used was decreased to 0.03 parts by mass and the amount of the solvent (IPA) used was increased to 23.07 parts by mass.

Then, the irregular surface of the anti-glare film was evaluated using stylus-type surface roughness measuring instrument (manufactured by Kosaka Laboratory Ltd.; trade name: Surfcorder ET4000). The results showed that the anti-glare film of Example 9 had substantially the same surface shape as that of Example 1, i.e., anti-glare properties.

### Example 10

An anti-glare film having a hard coat layer with a thickness of 7 μm was obtained as in Example 1 except that, as the viscosity modifier, instead of the carboxyl group-containing modified polymer (manufactured by Kyoeisha Chemical Co., Ltd.; trade name: G-700), modified urea (manufactured by BYK Japan KK; trade name: BYK-410) was used.

### Example 11

First, a master having an irregular shape on the surface was formed by blasting. Next, irregularities were formed on the surface of a TAC film (manufactured by Fuji Photo Film Co., Ltd.; film thickness: 80 μm) by a shape transfer process using the master. Next, using stylus-type surface roughness measuring instrument (manufactured by Kosaka Laboratory Ltd.; trade name: Surfcorder ET4000), the irregular shape of the surface of the base was evaluated. The results were as follows: Ra=0.509 μm, Rz=2.638 μm, and RSm=85 μm.

Next, an anti-glare film having a hard coat layer with a thickness of 7 μm was obtained as in Example 1 except that the TAC film described above was used.

### Example 12

An anti-glare film having a hard coat layer with a thickness of 4 μm was obtained as in Example 1 except that the ultraviolet curable resin composition having the composition described below was prepared by decreasing the amount of the silica filler used.

(Composition)

| | |
|---|---|
| Urethane acrylate | 21.76 parts by weight |
| Polyfunctional acrylic monomer | 10.88 parts by weight |
| Silica filler | 3.85 parts by weight |
| Polymerization initiator | 1.92 parts by weight |
| Leveling agent | 0.06 parts by weight |
| IPA solution of polystyrene sulfonic | 38.43 parts by weight |
| acid-doped polyethylenedioxythiophene | |
| Viscosity modifier | 0.04 parts by weight |
| IPA | 23.06 parts by weight |

Since the materials are the same as those in Example 1, description of names of supplier companies and trade names of the materials are omitted.

Then, the irregular surface was evaluated using stylus-type surface roughness measuring instrument (Surfcorder ET4000 manufactured by Kosaka Laboratory Ltd.). The results showed that the optical film of Example 12 had substantially the same surface shape as that of Example 1, i.e., anti-glare properties.

### Example 13

An anti-glare film having a hard coat layer with a thickness of 9 μm was obtained as in Example 1 except that the ultraviolet curable resin composition having the composition described below was prepared by increasing the amount of the silica filler used.

(Composition)

| | |
|---|---|
| Urethane acrylate | 11.52 parts by weight |
| Polyfunctional acrylic monomer | 5.76 parts by weight |
| Silica filler | 19.21 parts by weight |
| Polymerization initiator | 1.92 parts by weight |
| Leveling agent | 0.06 parts by weight |
| IPA solution of polystyrene sulfonic | 38.43 parts by weight |
| acid-doped polyethylenedioxythiophene | |
| Viscosity modifier | 0.04 parts by weight |
| IPA | 23.06 parts by weight |

Since the materials are the same as those in Example 1, description of names of supplier companies and trade names of the materials are omitted.

Then, the irregular surface was evaluated using stylus-type surface roughness measuring instrument (Surfcorder ET4000 manufactured by Kosaka Laboratory Ltd.). The results showed that the optical film of Example 13 had substantially the same surface shape as that of Example 1, i.e., anti-glare properties.

### Comparative Example 1

An anti-glare film having a hard coat layer with a thickness of 7 μm was obtained as in Example 1 except that the ultraviolet curable resin composition having the composition described below was prepared without using the silica filler, the viscosity modifier, and the conductive polymer.

(Composition)

| | |
|---|---|
| Urethane acrylate | 25.32 parts by mass |
| Polyfunctional acrylic monomer: | 12.66 parts by mass |
| pentaerythritol tetraacrylate | |
| Polymerization initiator | 2 parts by mass |
| Leveling agent: | 0.07 parts by mass |
| 3-methoxy-3-methyl-1-butanol | |
| solution of 30% by mass active | |
| constituent (fluorine-containing acrylic polymer) | |
| Solvent: isopropyl alcohol (IPA) | 59.95 parts by mass |

Since the materials are the same as those in Example 1, description of names of supplier companies and trade names of the materials are omitted.

With respect to the anti-glare films of Examples 1 to 11 and Comparative Example 1 obtained as described above, the following evaluations were performed.

(Surface Resistance)

The surface resistance was evaluated using a Hiresta-UP manufactured by Mitsubishi Chemical Corporation (probe: URS, voltage applied: 1,000 V).

(Film Hardness)

The film hardness was evaluated by measurement of Martens hardness and pencil hardness.

The Martens hardness was evaluated using a PICODENTOR HM500 manufactured by Fischer Instruments K.K. (load 5 mN).

The pencil hardness was evaluated according to JIS K5400 with a weight of 500 g.

(Haze, Total Light Transmittance)

The haze (JIS K7136) and the total light transmittance (JIS K7361) were evaluated using a HM-150 manufactured by Murakami Color Research Laboratory.

(Adhesion)

The adhesion was evaluated by a tape peel test according to JIS K5400 using a lattice pattern (100 squares, each 1 mm×1 mm) cellophane tape (CT24 manufactured by Nichiban Co., Ltd.).

(Antifouling Properties)

The antifouling properties were evaluated by the pure water contact angle (CA-XE type manufactured by Kyowa Interface Science Co., Ltd.), the fingerprint wiping-off property, and the repellency/wiping-off property of marker (Mckie black manufactured by Zebra Co., Ltd.).

(Irregular Surface Shape)

The irregular surface of the base before formation of the hard coat layer and the irregular surface of the hard coat layer were measured using stylus-type surface roughness measuring instrument (manufactured by Kosaka Laboratory Ltd.; trade name: Surfcorder ET4000). Evaluation was performed on the basis of the following criteria, and the evaluation results are shown in Table 2.

◯: Irregular surface following the irregular surface of the base is formed on the surface of the hard coat layer.
x: Irregular surface following the irregular surface of the base is not formed on the surface of the hard coat layer.

(Anti-Glare Properties)

The film was attached to a blackboard through an adhesive sheet, and glare caused by a fluorescent lamp was checked. Evaluation was performed on the basis of the following criteria, and the evaluation results are shown in Table 2.

◯: Anti-glare properties are exhibited, and the outline of the fluorescent lamp is blurred.
x: Anti-glare properties are not exhibited, and the outline of the fluorescent lamp glares clearly.

(Agglomerates)

The presence or absence of agglomerates was visually evaluated. Specifically, when agglomerates were visually recognized, agglomerates were evaluated to be present; and when agglomerates were not visually recognized, agglomerates were evaluated to be absent. The evaluation results are shown in Table 2.

Table 1 shows the structures of the anti-glare films of Examples 1 to 13 and Comparative Example 1.

TABLE 1

| | | Polyfunctional | Silica | Polymerization | | Conductive |
|---|---|---|---|---|---|---|
| | Urethane acrylate | acrylic monomer | filler | initiator | Leveling agent | polymer solution |
| | [parts by mass] | [parts by mass] | [parts by mass] | [parts by mass] | [parts by mass] | [parts by mass] |
| Example 1 | 14.08 | 7.04 | 15.37 | 1.92 | 0.06 | 38.43 |
| Example 2 | 12.20 | 6.10 | 13.32 | 1.67 | 0.06 | 46.63 |
| Example 3 | 11.44 | 5.72 | 12.49 | 1.56 | 0.05 | 49.97 |
| Example 4 | 13.82 | 6.91 | 15.37 | 1.92 | 0.06 | 38.43 |
| Example 5 | 13.82 | 6.91 | 15.37 | 1.92 | 0.06 | 38.43 |
| Example 6 | 13.82 | 6.91 | 15.37 | 1.92 | 0.06 | 38.43 |
| Example 7 | 13.82 | 6.91 | 15.37 | 1.92 | 0.06 | 38.43 |
| Example 8 | 14.08 | 7.04 | 15.37 | 1.92 | 0.06 | 38.43 |
| Example 9 | 14.08 | 7.04 | 15.37 | 1.92 | 0.06 | 38.43 |
| Example 10 | 14.08 | 7.04 | 15.37 | 1.92 | 0.06 | 38.43 |
| Example 11 | 14.08 | 7.04 | 15.37 | 1.92 | 0.06 | 38.43 |
| Example 12 | 21.76 | 10.88 | 3.85 | 1.92 | 0.06 | 38.43 |
| Example 13 | 11.52 | 5.76 | 19.21 | 1.92 | 0.06 | 38.43 |
| Comparative | 25.32 | 12.66 | — | 2.00 | 0.07 | — |
| Example 1 | | | | | | |

| | Antifouling | Viscosity | | HC layer | |
|---|---|---|---|---|---|
| | additive | modifier | Solvent | thickness | |
| | [parts by mass] | [parts by mass] | [parts by mass] | [μm] | Master |
| Example 1 | — | 0.04 (G-700) | 23.06 | 7 | Etching |
| Example 2 | — | 0.03 (G-700) | 19.99 | 7 | Etching |
| Example 3 | — | 0.03 (G-700) | 18.74 | 7 | Etching |
| Example 4 | 0.38 (RS-602) | 0.04 (G-700) | 23.07 | 7 | Etching |
| Example 5 | 0.38 (RS-751-K) | 0.04 (G-700) | 23.07 | 7 | Etching |
| Example 6 | 0.38 (DAC-HP) | 0.04 (G-700) | 23.07 | 7 | Etching |
| Example 7 | 0.38 (EBECRYL350) | 0.04 (G-700) | 23.07 | 7 | Etching |
| Example 8 | — | 0.05 (G-700) | 23.05 | 10 | Etching |
| Example 9 | — | 0.03 (G-700) | 23.07 | 4 | Etching |
| Example 10 | — | 0.04 (BYK-410) | 23.06 | 7 | Etching |
| Example 11 | — | 0.04 (G-700) | 23.06 | 7 | Blasting |
| Example 12 | — | 0.04 (G-700) | 23.06 | 4 | Etching |
| Example 13 | — | 0.04 (G-700) | 23.06 | 9 | Etching |
| Comparative | — | — | 59.95 | 7 | Etching |
| Example 1 | | | | | |

Table 2 shows the evaluation results of the anti-glare films of Examples 1 to 13 and Comparative Example 1.

TABLE 2

| | Surface | Martens | | | | | Antifouling properties |
|---|---|---|---|---|---|---|---|
| | resistivity | hardness | Pencil | | | | Pure water |
| | (Ω/square) | (N/mm²) | hardness | HAZE (%) | Tt (%) | Adhesion | contact angle (°) |
| Example 1 | 2 × 10¹⁰ | 411 | 4H | 0.8 | 91.8 | 100/100 | — |
| Example 2 | 1 × 10⁹ | 409 | 4H | 0.8 | 91.2 | 100/100 | — |
| Example 3 | 9 × 10⁸ | 406 | 4H | 0.8 | 90.9 | 100/100 | — |
| Example 4 | 1 × 10¹¹ | 409 | 4H | 0.8 | 91.3 | 100/100 | 108 |
| Example 5 | 1 × 10¹¹ | 410 | 4H | 0.8 | 91.3 | 100/100 | 108 |
| Example 6 | 9 × 10¹⁰ | 410 | 4H | 0.8 | 91.3 | 100/100 | 108 |
| Example 7 | 1 × 10¹¹ | 405 | 4H | 0.8 | 91.3 | 100/100 | 98 |
| Example 8 | — | — | — | — | — | — | — |
| Example 9 | — | — | — | — | — | — | — |
| Example 10 | — | — | — | — | — | — | — |
| Example 11 | 2 × 10¹⁰ | 411 | 4H | 0.8 | 91.8 | 100/100 | — |
| Example 12 | 2 × 10¹⁰ | 311 | 2H | 0.7 | 91.9 | 100/100 | — |
| Example 13 | 2 × 10¹⁰ | 460 | 4H | 0.8 | 91.6 | 100/100 | — |
| Comparative | 1 × 10¹⁵ | 312 | 2H | 0.8 | 92.2 | 100/100 | — |
| Example 1 | or more | | | | | | |

| | Antifouling properties | | | | | |
|---|---|---|---|---|---|---|
| | Fingerprint | | Marker | | | |
| | wiping-off | Marker | wiping-off | Irregular | Anti-glare | |
| | property | repellency | property | state | properties | Agglomerates |
| Example 1 | — | — | — | ∘ | ∘ | Absent |
| Example 2 | — | — | — | ∘ | ∘ | Absent |
| Example 3 | — | — | — | ∘ | ∘ | Absent |
| Example 4 | ∘ | ∘ | ∘ | ∘ | ∘ | Absent |
| Example 5 | ∘ | ∘ | ∘ | ∘ | ∘ | Absent |
| Example 6 | ∘ | ∘ | ∘ | ∘ | ∘ | Absent |
| Example 7 | ∘ | ∘ | ∘ | ∘ | ∘ | Absent |
| Example 8 | — | — | — | ∘ | ∘ | Absent |
| Example 9 | — | — | — | ∘ | ∘ | Absent |
| Example 10 | — | — | — | ∘ | ∘ | Present |
| Example 11 | — | — | — | ∘ | ∘ | Absent |
| Example 12 | — | — | — | ∘ | ∘ | Absent |
| Example 13 | — | — | — | ∘ | ∘ | Absent |
| Comparative | — | — | — | x | x | Absent |
| Example 1 | | | | | | |

The followings are evident from Tables 1 and 2.

### Examples 1 to 3 and Comparative Example 1

In Examples 1 to 3, since the ultraviolet curable resin composition contains the silica filler and the viscosity modifier, the irregular shape which follows the irregular shape of the film and which is moderately smooth is formed on the surface of the hard coat layer, thus exhibiting anti-glare properties. The reason for this is that, in the solvent evaporation process, the silica filler and the viscosity modifier form bonds, the viscosity of the ultraviolet curable resin composition increases, and thus the ultraviolet curable resin composition follows the irregular shape of the film. In contrast, in Comparative Example 1, since the ultraviolet curable resin composition does not contain the silica filler and the viscosity modifier, the irregular shape following the irregular shape of the film is not formed on the surface of the hard coat layer. Therefore, anti-glare properties are not exhibited. The reason for this is that, in the solvent evaporation process, the viscosity of the ultraviolet curable resin composition does not increase sufficiently, and the irregular shape of the film is flattened.

Furthermore, in Examples 1 to 3, since the ultraviolet curable resin composition contains the conductive polymer, the surface resistivity is decreased to about 10⁸ to 10 Ω/square. Thus, the antistatic effect is exhibited. In contrast, in Comparative Example 1, the surface resistivity is increased to 10¹⁵ or more, and the antistatic effect is not exhibited.

### Examples 4 to 7

In Examples 4 to 7, since the ultraviolet curable resin composition contains the antifouling agent, excellent antifouling properties are exhibited.

### Examples 8 and 9

When the amount of the viscosity modifier (G-700) used is increased, shape followability tends to be enhanced. That is, in order to obtain the anti-glare properties (surface shape) equivalent to Example 1, it is necessary to increase the thickness of the hard coat layer to be larger than that of Example 1. On the other hand, when the amount of the viscosity modifier (G-700) used is decreased, shape followability tends to be reduced. That is, in order to obtain the anti-glare properties (surface shape) equivalent to Example 1, it is necessary to decrease the thickness of the hard coat to be smaller than that of Example 1.

As is evident from the above, the amount of the viscosity modifier (G-700) to be used is preferably selected according to the desired thickness of the hard coat layer.

### Example 10

When the modified urea (BYK-410) is used, instead of the carboxyl group-containing modified polymer (G-700), as the viscosity modifier, there may be a case where agglomerates of the silica filler occur in the drying process after coating. The reason for this is believed to be that, since the network-forming power between the silica filler and the BYK-410 is stronger than that between the silica filler and the G-700, the filler is agglomerated.

### Example 11

When the anti-glare film is fabricated using the master formed by blasting, as in the case where the anti-glare film is fabricated using the master formed by photolithography, excellent anti-glare properties are obtained.

### Examples 12 and 13

When the amount of the silica filler used is increased, shape followability tends to be enhanced. That is, in order to obtain the anti-glare properties (surface shape) equivalent to Example 1 by increasing the amount of the silica filler used to be larger than that of Example 1, it is necessary to increase the thickness of the hard coat layer to be larger than that of Example 1. On the other hand, when the amount of the silica filler used is decreased, shape followability tends to be reduced. That is, in order to obtain the anti-glare properties (surface shape) equivalent to Example 1 by decreasing the amount of the silica filler to be lower than that of Example 1, it is necessary to decrease the thickness of the hard coat layer to be smaller than that of Example 1.

As is evident from the above, by appropriately adjusting the amounts of the silica filler and the viscosity modifier to be used, it is possible to obtain desired anti-glare properties (i.e., desired surface shape) at a desired thickness of the hard coat layer.

The embodiments and the examples of the present application have been described above in detail. However, it is to be understood that the present invention is not limited to the embodiments and the examples described above, and various alterations are possible.

For example, the structures, methods, shapes, materials, numerical values, etc. described in the embodiments and the examples are merely examples, and structures, methods, shapes, materials, numerical values, etc. different from those described above may be used as necessary.

Furthermore, the structures according to all the embodiments described above can be combined with each other without departing from the spirit and scope of the present application.

Furthermore, in the embodiments described above, an example in which the present application is applied to a display device has been described. However, the present application is also applicable to a touch panel or the like.

Furthermore, the anti-glare film according to the first embodiment described above may be used as an anti-Newton ring (ANR) film in a display device. By using the anti-glare film as the ANR film, it is possible to suppress the occurrence of a Newton ring or reduce the occurrence of a Newton ring to an ignorable extent.

Furthermore, in the embodiments described above, an example in which the anti-glare film is applied to a display device has been described. However, the anti-glare film according to the embodiments of the present application is also applicable to various types of display device other than the liquid crystal display device. For example, the anti-glare film according to the embodiments of the present application is also applicable to various types of display device, such as a cathode ray tube (CRT) display, a plasma display panel (PDP), an electroluminescence (EL) display, and a surface-conduction electron-emitter display (SED).

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An anti-glare film comprising:
a base having an irregular surface; and
a hard coat layer disposed on the irregular surface of the base,
wherein the surface of the hard coat layer has an irregular shape following the irregular surface of the base;
the hard coat layer is obtained by applying an ultraviolet curable resin composition to the irregular surface of the base, followed by drying and curing; and
the ultraviolet curable resin composition contains a monomer and/or oligomer having two or more (meth)acryloyl groups, a photopolymerization initiator, an inorganic oxide filler, a viscosity modifier, and a conductive polymer.

2. The anti-glare film according to claim 1, wherein the conductive polymer is polythiophene.

3. The anti-glare film according to claim 1, wherein the viscosity modifier is a compound having in its molecule a carboxyl group.

4. The anti-glare film according to claim 1, wherein the surface of the inorganic oxide filler forms bonds with the viscosity modifier.

5. The anti-glare film according to claim 4, wherein the bonds are hydrogen bonds or coordination bonds.

6. The anti-glare film according to claim 4, wherein the ultraviolet curable resin composition further contains a antifouling agent.

7. A display device comprising:
an anti-glare film;
a base having an irregular surface; and
a hard coat layer disposed on the irregular surface of the base,
wherein the surface of the hard coat layer has an irregular shape following the irregular surface of the base;
the hard coat layer is obtained by applying an ultraviolet curable resin composition to the irregular surface of the base, followed by drying and curing; and
the ultraviolet curable resin composition contains a monomer and/or oligomer having two or more (meth)acryloyl groups, a photopolymerization initiator, an inorganic oxide filler, a viscosity modifier, and a conductive polymer.

8. A method of manufacturing an anti-glare film comprising:
applying an ultraviolet curable resin composition to an irregular surface of a base;
drying the applied ultraviolet curable resin composition; and
curing the dried ultraviolet curable resin composition,
wherein the ultraviolet curable resin composition contains a monomer and/or oligomer having two or more (meth)acryloyl groups, a photopolymerization initiator, an inorganic oxide filler, a viscosity modifier, and a conductive polymer; and
in the drying step, the surface of the inorganic oxide filler forms bonds with the viscosity modifier, thereby increasing the viscosity of the ultraviolet curable resin composition, and the ultraviolet curable resin composition with the increased viscosity follows the irregular surface of the base.
